(19) United States
(12) Patent Application Publication
(10) Pub. No.: US 2022/0129767 A1
(43) Pub. Date: Apr. 28, 2022

(54) TRANSMITTER IDENTIFYING APPARATUS, TRANSMITTER IDENTIFYING METHOD, AND PROGRAM

(71) Applicant: NEC Corporation, Minato-ku, Tokyo (JP)

(72) Inventors: Taichi OHTSUJI, Tokyo (JP); Toshiki TAKEUCHI, Tokyo (JP); Tatsuya ABE, Tokyo (JP)

(73) Assignee: NEC Corporation, Minato-ku, Tokyo (JP)

(21) Appl. No.: 17/436,214

(22) PCT Filed: Feb. 17, 2020
(86) PCT No.: PCT/JP2020/005939

§ 371 Date: Sep. 3, 2021

(30) Foreign Application Priority Data
Mar. 18, 2019 (JP) 2019-049814

(51) Int. Cl. G06N 5/02; H04W 8/00; H04W 24/08

(52) U.S. Cl. CPC G06N 5/022; H04W 24/08; H04W 8/005

(57) ABSTRACT

Provided is a transmitter identifying apparatus configured to receive signals from terminals, extract a feature from the received signal, learn a first feature of the signal that is known as a signal received from a terminal to be discriminated, generate a first classifier for discriminating the terminal to be discriminated, input to the first classifier a second feature of the signal that is unknown whether the signal is received from the terminal to be discriminated, calculate a likelihood distribution representing likelihood for each terminal, analyze the likelihood distribution, determine whether to apply a tentative label to the second feature, and apply the tentative label to the second feature, based on a result of the analysis.

This application is a National Stage Entry of PCT/JP2020/005939 filed on Feb. 17, 2020, which claims priority from Japanese Patent Application 2019-049814 filed on Mar. 18, 2019, the contents of all of which are incorporated herein by reference, in their entirety.

### BACKGROUND

### Technical Field

The present invention relates to a transmitter identifying apparatus, a transmitter identifying method, and a program.

### Background Art

There are techniques for identifying wireless terminal apparatuses, such as portable terminal apparatuses. For example, NPL 1 discloses a radio wave discriminating system in which a receiver identifies (discriminates) a wireless terminal based on characteristics of a signal received from the wireless terminal. The radio wave discriminating system disclosed in NPL 1 converts the waveform of a known signal, such as a preamble signal, into a power spectral density. Thereafter, the radio wave discriminating system learns the power spectral density as a feature by using a machine learning algorithm, such as a k-nearest neighbor method, to generate a discriminative model. Then, the radio wave discriminating system inputs to the learned model the feature, which is extracted from the received signal, and discriminates a terminal that has transmitted the signal among learned wireless terminals.

Normally, discrimination of a wireless terminal employs a supervised algorithm among machine learning algorithms. The supervised algorithm labels learning data (feature) in learning. In one example, learning data 1 is labeled with “transmitter A”, and learning data 2 is labeled with “transmitter B”, whereby these pieces of data are used as supervised data. In order to enhance discrimination performance (classification performance) of a learning model, labels that are applied to features included in a learning set needs to be appropriate.

### CITATION LIST

### Non Patent Literature

[NPL 1] S. U. Rehman, K. Sowerby, and C. Coghill, “Analysis of Receiver Front End on the Performance of RF Fingerprinting”, 2012 IEEE International Symposium on Personal, Indoor, and Mobile Radio Communications (PIMRC), pp. 2494-2499, 2012.

### SUMMARY

### Technical Problem

In order to improve accuracy (discrimination accuracy) of identifying a transmitter (transmitting apparatus) of a radio wave transmission source, it is necessary to learn a discriminative model by using sufficient amount of learning data. In other words, the discriminative model needs to be constructed by using learning data that has sufficiently high accuracy.

In particular, in order to generate a discriminative model having robustness (high resistance) against environmental variation, it is desirable to generate a discriminative model by using features that are extracted from signals having various signal-to-noise ratios (SNRs) or signals having been propagated through a plurality of radio wave propagation environments being different from each other.

For example, in an environment where a large number of unspecific terminals can transmit radio waves, such as in an outdoor location, signals from a plurality of unknown wireless terminals, in addition to a specific wireless terminal that is desired to be learned for a discriminative model, may be received and used in constructing the discriminative model. In this case, it tends to be difficult to extract a signal of the specific terminal from the signals mixed with signals of the unknown terminals and to apply a label, which indicates the feature of the corresponding terminal, to the extracted signal (feature).

In other words, it is difficult to use data that is obtained in the environment where a large number of unspecific terminals can transmit radio waves, as learning data, which causes difficulty in generating a discriminative model having robustness against environmental variation. This is similar in the technique of NPL 1, and a discriminative model having robustness against environmental variation is not generated even when the technique disclosed in NPL 1 is employed.

An example object of the present invention is to provide a transmitter identifying apparatus, a transmitter identifying method, and a program that enable generating a discriminative model having robustness against environmental variation.

### Solution to Problem

According to a first example aspect of the present invention, there is provided a transmitter identifying apparatus including: a receiving unit configured to receive a signal from each of terminals; a feature extracting unit configured to extract a feature from the signal received by the receiving unit; a first learning unit configured to learn a first feature of the signal that is known as a signal received from a terminal to be discriminated, and generate a first classifier for discriminating the terminal to be discriminated; a likelihood calculation unit configured to input to the first classifier a second feature of the signal that is unknown whether the signal is received from the terminal to be discriminated, and calculate a likelihood distribution representing a likelihood for each terminal; an analyzing unit configured to analyze the likelihood distribution, and determine whether to apply a tentative label to the second feature; and a label applying unit configured to apply the tentative label to the second feature, based on a result of the analyzing unit.

According to a second example aspect of the present invention, there is provided a transmitter identifying method performed by a transmitter identifying apparatus including a receiving unit for receiving a signal from each of terminals. The transmitter identifying method includes: extracting a feature from the signal received by the receiving unit; learning a first feature of the signal that is known as a signal received from a terminal to be discriminated, and generating a first classifier for discriminating the terminal to be discriminated; inputting to the first classifier a second feature of the signal that is unknown whether the signal is received from the terminal to be discriminated, and calculating a likelihood distribution representing a likelihood for each terminal; analyzing the likelihood distribution, and determining whether to apply a tentative label to the second feature; and applying the tentative label to the second feature, based on a result of the analysis.

According to a third example aspect of the present invention, there is provided a program causing a computer mounted on a transmitter identifying apparatus including a receiving unit for receiving a signal from each of terminals to execute the processes of: extracting a feature from the signal received by the receiving unit; learning a first feature of the signal that is known as a signal received from a terminal to be discriminated, and generating a first classifier for discriminating the terminal to be discriminated; inputting to the first classifier a second feature of the signal that is unknown whether the signal is received from the terminal to be discriminated, and calculating a likelihood distribution representing a likelihood for each terminal; analyzing the likelihood distribution, and determining whether to apply a tentative label to the second feature; and applying the tentative label to the second feature, based on a result of the analysis.

### Advantageous Effects of Invention

Each example aspect of the present invention provides a transmitter identifying apparatus, a transmitter identifying method, and a program that enable generating a discriminative model having robustness against environmental variation. Note that, according to the present invention, instead of or together with the above effects, other effects may be exerted.

### BRIEF DESCRIPTION OF THE DRAWINGS

FIG. 1 is a diagram for describing an overview of an example embodiment;

FIG. 2 is a block diagram illustrating an example of a functional configuration of a transmitter identifying apparatus according to a first example embodiment;

FIG. 3 is a diagram illustrating a disposition example of the transmitter identifying apparatus and transmitters;

FIG. 4 is a diagram illustrating an overall flow of an operation example of the transmitter identifying apparatus according to the first example embodiment;

FIG. 5 is a diagram illustrating a processing flow relating to label applying processing performed on a second feature by the transmitter identifying apparatus according to the first example embodiment;

FIG. 6 is a diagram illustrating a processing flow relating to analysis of a likelihood distribution by the transmitter identifying apparatus according to the first example embodiment;

FIG. 7 is a diagram for describing operation of the transmitter identifying apparatus according to the first example embodiment;

FIG. 8 is a block diagram illustrating an example of a functional configuration of a transmitter identifying apparatus according to a second example embodiment;

FIG. 9 is a diagram illustrating an overall flow of an operation example of the transmitter identifying apparatus according to the second example embodiment;

FIG. 10 is a diagram illustrating a processing flow relating to analysis of a likelihood distribution by a transmitter identifying apparatus according to a third example embodiment;

FIG. 11 is a block diagram illustrating an example of a functional configuration of a transmitter identifying apparatus according to a fourth example embodiment;

FIG. 12 is a diagram illustrating an overall flow of an operation example of the transmitter identifying apparatus according to the fourth example embodiment;

FIG. 13 is a flowchart illustrating an example of operation of the transmitter identifying apparatus according to the fourth example embodiment;

FIG. 14 is a diagram illustrating an overall flow of an operation example of the transmitter identifying apparatus according to the fourth example embodiment; and

FIG. 15 is a diagram illustrating an example of a hardware configuration of the transmitter identifying apparatus according to the first example embodiment.

### DESCRIPTION OF THE EXAMPLE EMBODIMENTS

First, an overview of an example embodiment will be described. Note that the reference signs in the drawing described in this overview are added to respective elements as an example for convenience of understanding, and these expressions in the overview are by no means intended to impose limitations. Note that, in the Specification and drawings, elements to which similar descriptions are applicable are denoted by the same reference signs, and overlapping descriptions may hence be omitted.

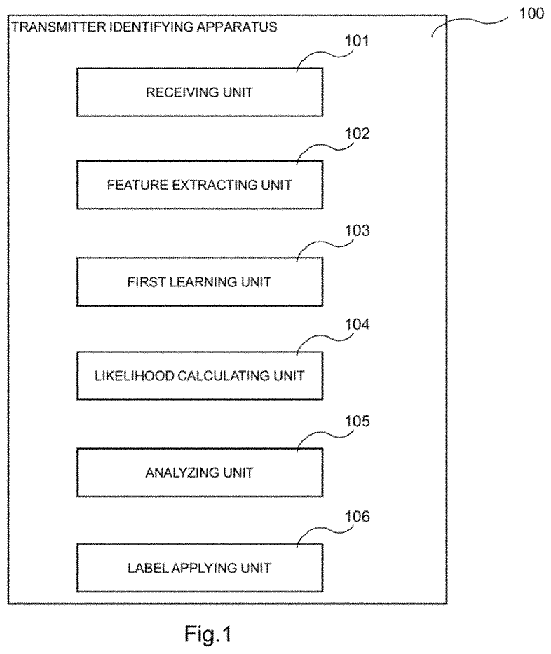

A transmitter identifying apparatus 100 according to an example embodiment includes a receiving unit 101, a feature extracting unit 102, a first learning unit 103, a likelihood calculating unit 104, an analyzing unit 105, and a label applying unit 106 (refer to FIG. 1). The receiving unit 101 receives signals from terminals. The feature extracting unit 102 extracts a feature from a received signal that is received by the receiving unit 101. The first learning unit 103 learns a first feature of the signal that is known as a signal received from a terminal to be discriminated, and generates a first classifier for discriminating the terminal to be discriminated. The likelihood calculating unit 104 inputs to the first classifier a second feature of a signal that is unknown whether the signal is received from the terminal to be discriminated, and calculates a likelihood distribution representing likelihood for each terminal. The analyzing unit 105 analyzes the likelihood distribution, and determines whether to apply a tentative label to the second feature. The label applying unit 106 applies the tentative label to the second feature based on the result of the analyzing unit 105.

The transmitter identifying apparatus 100 calculates a likelihood distribution relating to a feature for an unknown transmission source by using a discriminative model (classifier) that is generated under an ideal environment where only a terminal to be discriminated transmits radio waves. The transmitter identifying apparatus 100 analyzes the likelihood distribution. In a case where the feature of the terminal to be discriminated is recognized in the received signal, the transmitter identifying apparatus 100 applies a label (tentative label) to the feature of the received signal. On the other hand, in a case where the analysis of the likelihood distribution indicates that the received signal has no feature of the target to be discriminated, the transmitter identifying apparatus 100 does not apply a label (tentative label) to the feature of the received signal. As a result, the transmitter identifying apparatus 100, which identifies a transmission source from a received radio wave, can apply an appropriate label to a feature of a specific terminal among signals transmitted from a large number of unspecific terminals when identifying a transmitter of a radio wave transmission source. In other words, the transmitter identifying apparatus 100 can generate a discriminative model having robustness against environmental variation.

Hereinafter, specific example embodiments will be described in more detail with reference to the drawings.

### First Example Embodiment

A first example embodiment will be described in detail by using the drawings.

### <Description of Configuration>

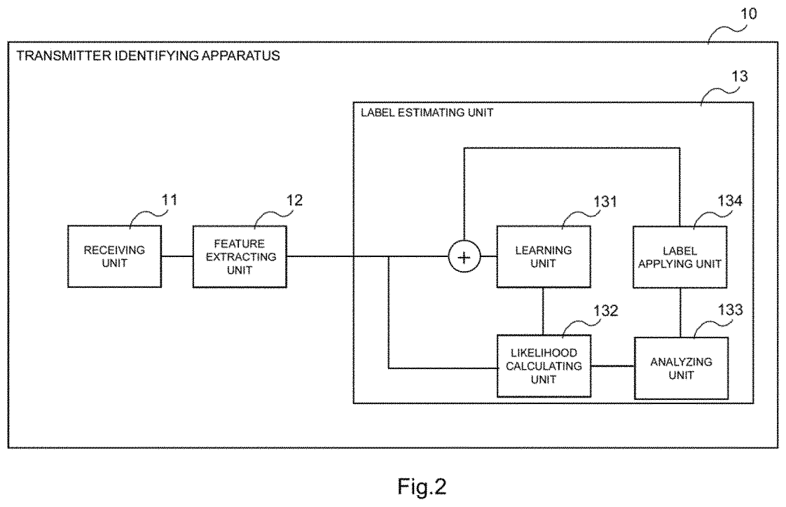

FIG. 2 is a block diagram illustrating an example of a functional configuration of the transmitter identifying apparatus 10 according to the first example embodiment. In the configuration illustrated in FIG. 2, the transmitter identifying apparatus 10 includes a receiving unit 11, a feature extracting unit 12, and a label estimating unit 13.

The transmitter identifying apparatus 10 identifies a transmitter, based on individual differences in radio wave transmitted from transmitters (not illustrated in FIG. 2). Note that the word “identify” can be interchanged with “discriminate”, “determine”, and so on.

Here, transmitted radio waves can have individual differences due to differences in specifications for transmitters, variations in characteristics of analog circuits that are mounted on transmitters although transmitters have the same specification, etc. The transmitter identifying apparatus 10 learns in advance, with respect to each transmitter, a feature of a radio wave that is transmitted from the transmitter. When receiving a radio wave, the transmitter identifying apparatus 10 extracts a feature from the received signal. The transmitter identifying apparatus 10 inputs the extracted feature to the learning model to identify the transmitter that is the transmission source of the received radio wave.

The identification of the transmitter includes “individual discrimination” for identifying an individual transmitter. The identification of the transmitter also includes “device type discrimination” for identifying the type of device that has transmitted the radio wave, instead of identifying the individual transmitter that has transmitted the radio wave. Depending on such a situation, the “individual discrimination” and the “device type discrimination” may be collectively referred to as “radio wave discrimination” in the following descriptions.

The transmitter identifying apparatus 10 is configured to extract a feature of a received radio wave (received radio signal). It is not necessary for a transmitter to transmit a radio wave to the transmitter identifying apparatus 10 (toward the transmitter identifying apparatus 10). The transmitter identifying apparatus 10 can be utilized (applied) for various purposes, such as for detecting and tracking a suspicious person in an urban area or various types of facility (airport, shopping mall, and the like), or for understanding flow lines of customers in a store or a commercial facility.

The transmitter identifying apparatus 10 can determine the identity of the transmitter by using the feature of the radio wave. However, the transmitter identifying apparatus 10 cannot directly identify the owner of the transmitter, based on the feature. In this manner, the feature of the radio wave that is used by the transmitter identifying apparatus 10 is anonymous, and the transmitter identifying apparatus 10 performs processing in consideration of a personal privacy.

The receiving unit 11 receives radio waves (radio signals) from transmitters, including a transmitter from which a radio wave is to be discriminated. Note that the number of the receiving units 11 of the transmitter identifying apparatus 10 is one or more. In other words, the transmitter identifying apparatus 10 includes at least one or more receiving units 11.

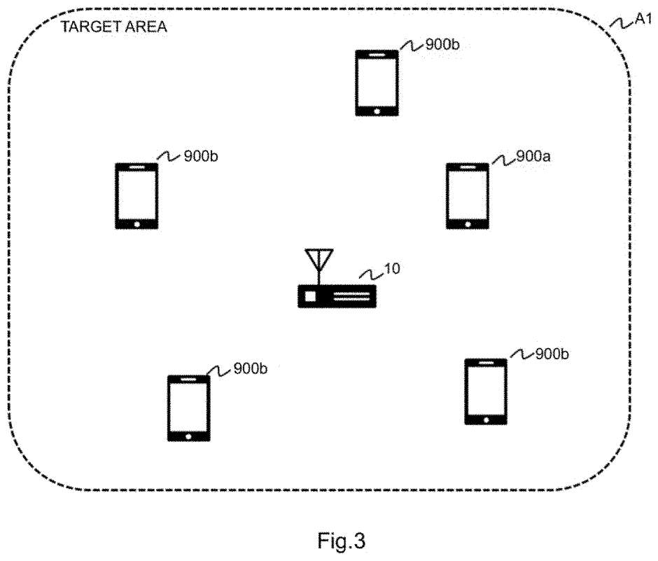

FIG. 3 is a diagram illustrating a disposition example of the transmitter identifying apparatus 10 including the receiving unit 11, and transmitters. The example in FIG. 3 illustrates the transmitter identifying apparatus 10 and transmitters 900a and 900b that are located in a target area A1 where individual discrimination is to be performed. Note that the transmitter 900a is a transmitter to be discriminated by the transmitter identifying apparatus 10, whereas the transmitters 900b are transmitters to not be discriminated by the transmitter identifying apparatus 10. In the present disclosure, unless otherwise required to distinguish the transmitters 900a and 900b from each other, they are simply described as “transmitters 900”. Note that, although FIG. 3 illustrates one transmitter 900a to be discriminated, a plurality of transmitters 900a to be discriminated are included in actual cases. In other words, at least one or more transmitters 900a exist in a field (target area).

Examples of the transmitter 900 include a portable terminal apparatus such as a smartphone, a mobile telephone, a game machine, and a tablet, and a computer (personal computer, laptop computer). Alternatively, the transmitter 900 may be an IoT (Internet of Things) terminal that transmits radio waves, an MTC (Machine Type Communication) terminal, or the like. However, the transmitters 900 (including a target from which a radio wave is to be discriminated by the transmitter identifying apparatus 10) are not limited to the examples described above. In other words, in the present disclosure, any apparatus that transmits radio waves can be a target from which a radio wave is to be discriminated by the transmitter identifying apparatus 10.

As described above, it is not necessary that the radio wave transmitted by the transmitter 900a is a radio wave transmitted to the transmitter identifying apparatus 10 (receiving unit 11). For example, the receiving unit 11 may receive a radio wave that is transmitted to a portable communication base station or an access point by the transmitter 900 or may receive a radio wave that is transmitted by the transmitter 900 in order to search for a portable communication base station or an access point.

In a case where the transmitter identifying apparatus 10 is located in an environment where a large number of unspecific transmitters can transmit signals, it may be difficult for the transmitter identifying apparatus 10 to extract a feature from a signal transmitted by a specific transmitter 900a and to apply an appropriate label to the feature. In other words, in a case where a large number of unspecific transmitters 900b and the transmitter 900a to be discriminated exist together, it may be difficult for the transmitter identifying apparatus 10 to discriminate the transmitter 900a correctly.

Meanwhile, in a case where the transmitter identifying apparatus 10 applies an inappropriate label to the extracted feature, recognition accuracy of the transmitter identifying apparatus 10 may be reduced. In more detail, applying an inappropriate label to a feature may reduce accuracy (discrimination accuracy) for identifying the individual transmitter 900a or the device type of the transmitter 900a by the transmitter identifying apparatus 10.

Note that the above-described appropriate label represents a transmitter (wireless terminal) and is, for example, a device type name, an individual ID, or a serial number. In other words, the label is information for discriminating and identifying a transmitter. In machine learning, unless a combination of a feature and a correct label as a learning data set is provided in constructing a discriminative model, a correct discrimination (classification) result is not obtained.

In view of this, in the transmitter identifying apparatus 10, the label estimating unit 13 has a function of estimating a label of a transmitter. Note that the term “label estimation” in the present disclosure represents the following processing: a classifier is made to learn in advance a feature that is obtained in the environment where only a specific transmitter transmits radio waves and that is applied with an appropriate label; and then, a label is estimated by using the classifier, with respect to an unlabeled feature that is obtained in the environment where a large number of unspecific transmitters transmit signals. In other words, a relationship between a transmitter and a feature of a signal transmitted by the transmitter is learned in advance in the ideal environment (environment where no terminal exists other than the terminal to be discriminated). Thereafter, the transmitter identifying apparatus 10 estimates labels of signals that are transmitted by a large number of unspecific transmitters, by using the discriminative model constructed as a result of the learning.

The description is returned to FIG. 2. The feature extracting unit 12 extracts a feature from a received signal that is received by the receiving unit 11. The feature, which is used to identify a transmitter of a radio wave transmission source by the transmitter identifying apparatus 10, can include any of various types of feature in which the individual differences between the transmitters 900 appear.

Examples of the feature include a transient (rising phase and falling phase) of the signal received by the receiving unit 11, a power spectral density of a reference signal part, such as a preamble, an error vector amplitude, an IQ phase (in-phase, quadrature phase) error, and an IQ imbalance amount. Alternatively, a feature that represents one or multiple of a frequency offset and a symbol clock error may be used. Note that these features are examples and are not intended to limit the feature to be used to identify a transmitter by the transmitter identifying apparatus 10.

The label estimating unit 13 includes a learning unit 131, a likelihood calculating unit 132, an analyzing unit 133, and a label applying unit 134.

The label estimating unit 13 applies an appropriate label to the received signal, based on the feature extracted by the feature extracting unit 12. In other words, the label estimating unit 13 performs radio wave discrimination (individual discrimination, device type discrimination), based on the extracted feature.

The learning unit 131 learns a data group of features (first features), which are obtained in the environment where only specific transmitters transmit signals and are applied with appropriate labels, and outputs a first classification model. Specifically, the learning unit 131 learns a feature (first feature) of the signal that is known as being received from the terminal to be discriminated, and generates a classifier (discriminative model) for discriminating the terminal to be discriminated. For example, in the example in FIG. 3, a first classification model is generated by using a radio wave (signal) that is transmitted by the transmitter 900a in an environment where the transmitters 900b do not exist.

More specifically, the learning unit 131 performs machine learning using supervised data that contains a labeled feature, and generates the first classification model (discriminator). The generation of the classification model by the learning unit 131 can employ any algorithm such as a support vector machine, boosting, or a neural network. Note that these algorithms, such as the support vector machine, can use a publicly known technique, and therefore, descriptions thereof are omitted.

The likelihood calculating unit 132 uses, as input data, an unlabeled feature (second feature) that is obtained in the environment where a large number of unspecific transmitters transmit signals, uses the classification model, which is learned by the learning unit 131, and outputs a likelihood distribution representing likelihood, for each device type of the transmitter or individual transmitter. In other words, the likelihood calculating unit 132 inputs to the classifier a feature (second feature) of a signal that is unknown whether the signal is received from the terminal to be discriminated, and calculates the likelihood distribution representing likelihood for each terminal.

The analyzing unit 133 analyzes the likelihood distribution, and determines whether to apply a tentative label to the second feature (unlabeled feature). More specifically, the analyzing unit 133 outputs a signal for permitting application of the tentative label in a case where the likelihood distribution satisfies a predetermined condition. Otherwise, in a case where the condition is not satisfied, the analyzing unit 133 outputs non-permission of application of the tentative label. Details of a concrete operation example of the analyzing unit 133 will be described later.

The label applying unit 134 applies the tentative label to the second feature in a case where the output of the analyzing unit 133 indicates permission of application of the tentative label. On the other hand, the label applying unit 134 does not apply the tentative label to the second feature in a case where the output of the analyzing unit 133 indicates non-permission of application of the tentative label.

The learning unit 131 relearns both of the labeled first feature and the second feature that is applied with the tentative label to update the discriminative model. This loop (repetitive processing) is repeated until increase of the number of second features that are applied with the tentative labels becomes 0. In other words, the loop processing is repeated until the second features to which the tentative labels are newly applied are used up.

### <Description of Operation>

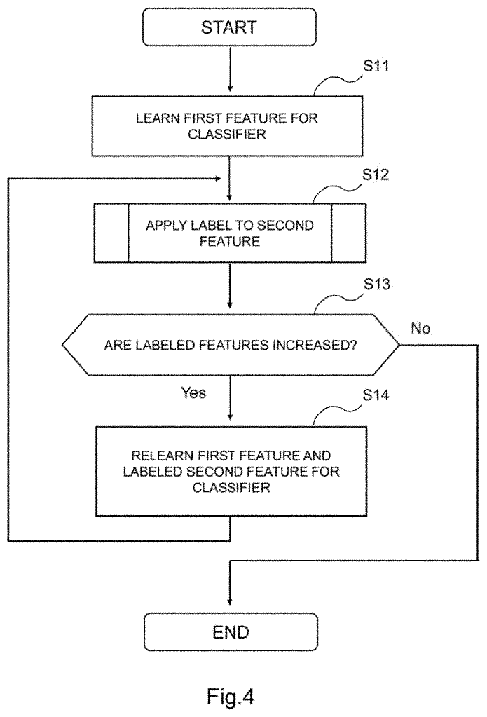

Hereinafter, operation of the first example embodiment will be described with reference to the flowcharts in FIGS. 4 to 6. FIG. 4 is a diagram illustrating an overall flow of an operation example of the transmitter identifying apparatus 10 according to the first example embodiment.

First, in the environment where only a specific transmitter transmits radio waves, the transmitter identifying apparatus 10 operates the receiving unit 11 to receive a signal transmitted by the transmitter.

The feature extracting unit 12 extracts a radio wave feature from the received signal, and applies a label representing the transmitter to the radio wave feature (first feature).

The learning unit 131 learns the radio wave feature to generate a discriminative model (classifier for discrimination) (step S11).

Next, in the environment where a large number of unspecific transmitters can transmit signals, the transmitter identifying apparatus 10 operates the receiving unit 11 to receive a signal transmitted by a transmitter.

The feature extracting unit 12 extracts a radio wave feature (second feature) from the received signal. The terminal that has transmitted the radio wave is unknown at this stage, and thus a label is not applied.

The label estimating unit 13 performs the label estimation for the second feature by using the discriminative model (step S12).

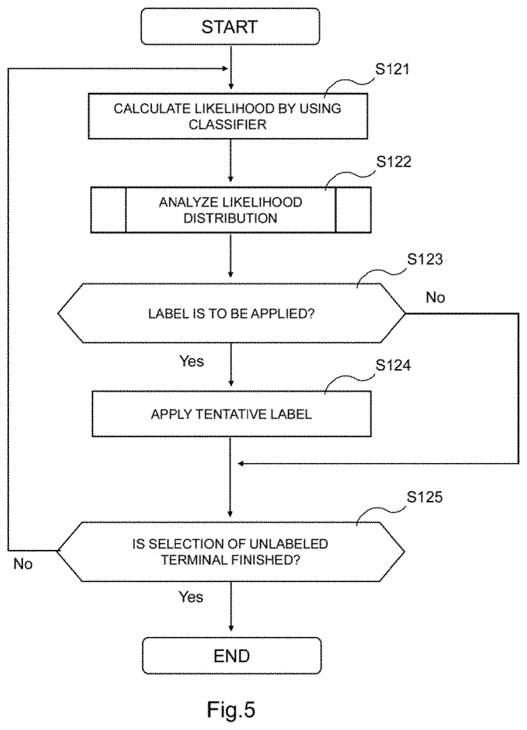

Note that the details of step S12 are described with reference to FIG. 5. FIG. 5 is a diagram illustrating a processing flow relating to labeling processing performed for the second feature.

The likelihood calculating unit 132 inputs the second feature to the discriminative model generated in step S11, calculates likelihood for each label, and outputs a likelihood distribution (step S121). For example, in a case where there are five types (classes) of device type labels or individual labels 0 to 4 for the first feature, five values each representing likelihood are output. This is a likelihood distribution. For example, it is assumed a case in which five transmitters (transmitters A to E) to be discriminated are provided. In this case, in response to input of the second feature to the discriminative model, a likelihood value relating to each of the transmitters A to E is output. In other words, as to the obtained second feature, likelihood values are calculated for labels corresponding to the respective transmitters A to E, and are output as the likelihood distribution.

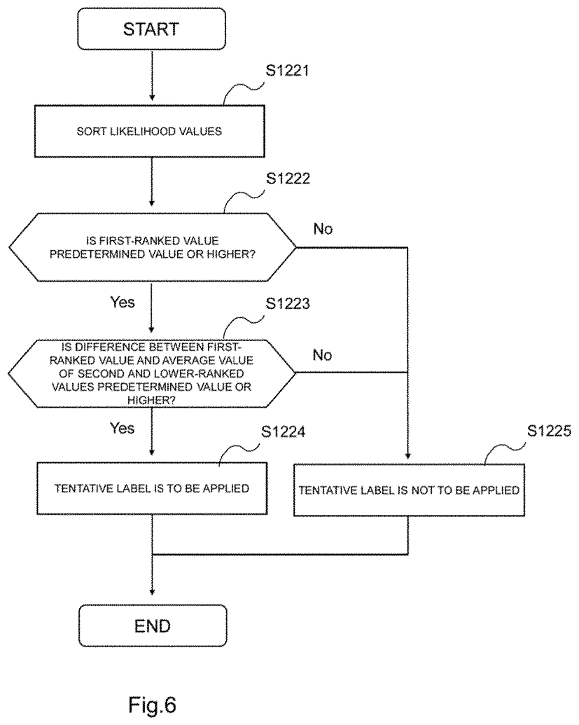

The analyzing unit 133 analyzes the likelihood distribution generated in step S121, and determines whether to apply a tentative label (step S122). An example of operation in step S122 is described in detail with reference to FIG. 6. FIG. 6 is a diagram illustrating a processing flow relating to step S122 (analysis of the likelihood distribution).

The analyzing unit 133 sorts the likelihood values of the likelihood distribution (step S1221). More specifically, the analyzing unit 133 sorts the output likelihood values, in descending order.

The analyzing unit 133 determines whether the likelihood value ranked first (highest likelihood value) as a result of sorting, is a first predetermined value or higher (step S1222).

Then, the analyzing unit 133 determines whether a difference between the first-ranked value and an average value of the second and lower-ranked likelihood values, is a second predetermined value or higher (step S1223). In other words, the analyzing unit 133 determines whether the difference value between the highest likelihood value and the average value of likelihood values other than the highest likelihood value, is the second predetermined value or higher.

For example, in a case where there are five types (classes) of device type labels or individual labels 0 to 4 for the first feature, the average value of the second and lower-ranked likelihood values refers to a value obtained by dividing the total of the second to fifth-ranked likelihood values by 4. In this case, the analyzing unit 133 determines whether the difference between the first-ranked value and the average value (value obtained by dividing the total of the four likelihood values by 4) is the predetermined value or higher.

In a case where the analyzing unit 133 determines as Yes in both of steps S1222 and S1223, the analyzing unit 133 judges to apply the tentative label (step S1224). On the other hand, in a case where the analyzing unit 133 determines as No in one or both of steps S1222 and S1223, the analyzing unit 133 judges to not apply the tentative label (step S1225).

The description is returned to FIG. 5. The label applying unit 134 applies the tentative label to the second feature that is judged to be applied with the label in step S122 (Yes in step S123, step S124).

The label applying unit 134 does not apply the tentative label to the second feature that is judged to not be applied with the label in step S122 (No in step S123).

The label estimating unit 13 continues the processing in step S12 until the processing from step S121 to step S124 are finished with respect to every second feature (“No” at branch in step S125).

The description is returned to FIG. 4. Step S13 is not executed at the first loop (processing on the “Yes” side in step S13 is executed). The learning unit 131 relearns the first feature that is extracted in step S11 and the second feature that is applied with the tentative label in step S12, to regenerate the discriminative model (classifier for discrimination) (step S14).

Then, until increase of the number of second features that are applied with the tentative labels in the processing in step S12 becomes 0, the processing of step S12 and step S14 is repeated.

Next, an example of a method for determining the two predetermined values will be described.

The receiving unit 11 adds additive Gaussian noise (additive white Gaussian noise (AWGN)) to the signal at the time the first feature is obtained. The addition of the additive Gaussian noise is performed on a computer. At this time, the receiving unit 11 desirably greatly varies a signal-to-noise ratio (SNR) (for example, −3 dB to 30 dB).

Then, the feature extracting unit 12 extracts a radio wave feature from the signal to which the additive Gaussian noise is added.

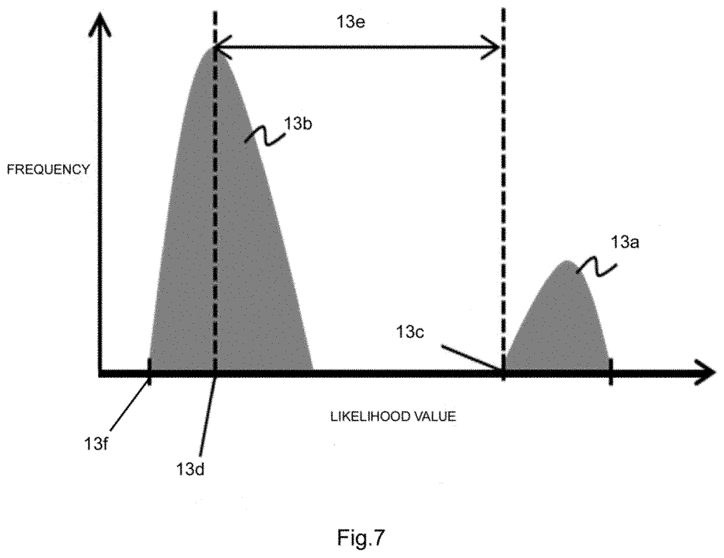

The learning unit 131 generates a discriminative model by using some (for example, approximately 80%) of the features. Thereafter, verification is performed with the generated discriminative model by using the rest (for example, approximately 20%) of the features, and a probability density distribution of the likelihood values is output (for example, refer to FIG. 7).

In short, the transmitter identifying apparatus 10 intentionally adds noise to a signal that is received in the ideal environment. At this time, the transmitter identifying apparatus 10 varies the level (magnitude) of the noise to be added. This results in generation of a plurality of received signals having different levels of added noise. The transmitter identifying apparatus 10 calculates a feature for each of the plurality of the signals. The transmitter identifying apparatus 10 generates a discriminative model by using a part of the plurality of the features. The transmitter identifying apparatus 10 inputs the rest of the features to the generated model, and calculates a likelihood value for each of the features. The calculated likelihood value is set on a horizontal axis, and the number (frequency) of the likelihood values is set on the vertical axis, whereby a probability density distribution, as illustrated in FIG. 7, is obtained.

In the case where only a specific transmitter exists, as illustrated in FIG. 7, the probability density distribution clearly has two peaks: a peak (13a) in which the likelihood values are closer to 1, and a peak (13b) in which the likelihood values are closer to 0. In other words, the peak (peak 13a) is formed by a set of the likelihood values which are obtained in a case where a feature of the signal transmitted by the specific transmitter remains uncanceled by the noise. The minimum value (13c) of the peak 13a can be used as the first predetermined value. Thus, the lowest likelihood value that represents the feature of the specific transmitter in the received signal, is set as the first predetermined value.

Note that with reference to FIG. 7, the peak is also formed in a low-likelihood value region. This peak can be understood as being formed of a set of results that are obtained by inputting, to the discriminative model, features of signals received from transmitters different from the discrimination target. In view of this, even when a feature of a signal received from a transmitter other than the discrimination target is input to the discriminative model, the likelihood values thereof tend to be 0 or greater and very small. A set of such small values forms the peak 13b. A difference (13e) between the mode (13d) of the peak 13b and the value 13c can be used as the second predetermined value. In other words, the second predetermined value (threshold value) can be set to the difference value between the highest likelihood value and an average value of likelihood values other than the highest likelihood value.

Step S1223 illustrated in FIG. 6 determines the difference (distance) between the maximum likelihood value and the average value of the rest of the likelihood values. This determination process excludes a case where, even when a likelihood value is high, a feature corresponding to the likelihood value is very likely to be a feature of another label. For example, in a case where the likelihood value of the transmitter A is sufficiently high and the likelihood values of the other transmitters B to E are close to the likelihood value of the transmitter A, the feature of the received signal does not correspond to the transmitter A and may correspond to any one of the other transmitters B to E. The determination process in step S1223 is executed in order to prevent such a possibility (erroneous result in determination). For this reason, the second predetermined value to be used in the determination process is selected from the point of view of sufficiently obtaining a distance from a peak with higher likelihood values, in order to prevent the erroneous determination.

Therefore, on the basis of the above-described point of view, in stead of the difference 13e illustrated in FIG. 7, assuming that the standard deviation of the peak 13a is represented as “σ”, the second predetermined value may be changed to a value that is obtained by subtracting 3σ from the average value of the peak 13a. Alternatively, the second predetermined value may be determined based on the number of times of repetition of the labeling loop or the SNR of the received signal.

### <Description of Advantageous Effects>

As described above, the transmitter identifying apparatus 10 includes the receiving unit 11, the feature extracting unit 12, and the label estimating unit 13. The label estimating unit 13 includes the learning unit 131, the likelihood calculating unit 132, the analyzing unit 133, and the label applying unit 134. With this configuration, the transmitter identifying apparatus 10 can apply an appropriate label to the feature that is extracted from received data, in the environment where a large amount of unspecific transmitters can transmit signals.

In other words, the transmitter identifying apparatus 10 learns the feature relating to the signal from the transmitter to be discriminated, in the ideal environment, and constructs a discriminative model. The transmitter identifying apparatus 10 labels a feature (identifies the transmitter) relating to the signal obtained in an operation environment of a system (environment where a large number of unspecific transmitters exist and being noisy). At this time, the transmitter identifying apparatus 10 performs the two-step determination process using the two predetermined values to determine whether to apply the tentative label to an unknown signal, to prevent applying a wrong label to the feature. Thus, a correct label is applied to the feature, and this newly labeled feature and the feature that is obtained in the ideal environment are used to reconstruct the discriminative model (relearn the feature), whereby accuracy of the discriminative model is improved. This results in generation of a discriminative model having robustness against environmental variation.

### Second Example Embodiment

Next, a second example embodiment will be described in detail with reference to the drawings.

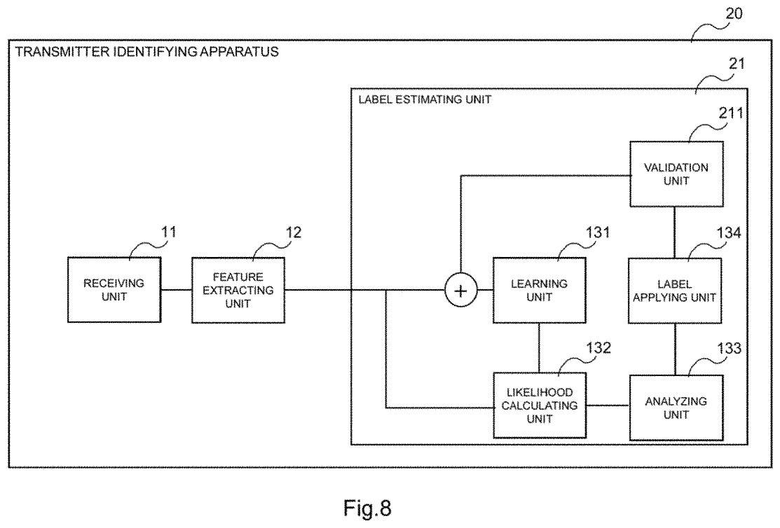

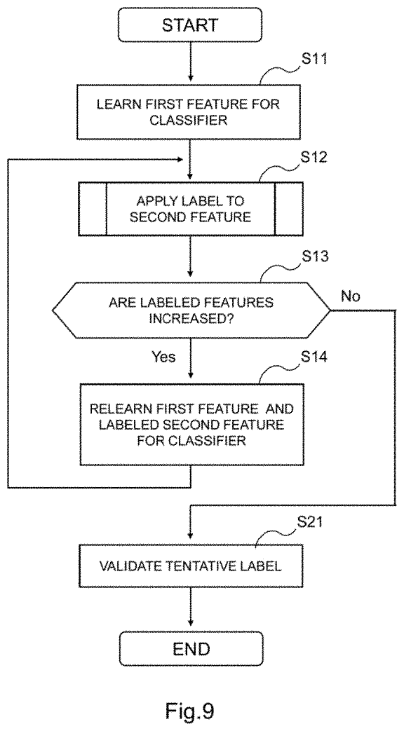

In the second example embodiment, an example alteration of the first example embodiment will be described. In order to enhance discrimination performance (classification performance) of a learning model, labels that are applied to features included in a learning set needs to be appropriate. In other words, containing a feature that is applied with an incorrect label in a data set may reduce the discrimination performance. In the second example embodiment, a block (validation unit 211 in FIG. 8) and a process (step S21 in FIG. 9) for validating whether the tentative label applied to the second feature is appropriate, are added to the label estimating unit 13.

### <Description of Configuration>

FIG. 8 is a block diagram illustrating an example of a functional configuration of a transmitter identifying apparatus according to the second example embodiment. In the configuration illustrated in FIG. 8, a transmitter identifying apparatus 20 includes a receiving unit 11, a feature extracting unit 12, and a label estimating unit 21. In the second example embodiment, the same constituent components as those in the first example embodiment are denoted by the same numbers, and descriptions thereof are omitted.

The label estimating unit 21 includes a learning unit 131, a likelihood calculating unit 132, an analyzing unit 133, a label applying unit 134, and a validation unit 211. The label estimating unit 21 of the second example embodiment is configured by adding the validation unit 211 to the label estimating unit 13 of the first example embodiment.

The validation unit 211 validates whether the tentative label applied to the second feature is correct (appropriate), after the loop for updating the discriminative model described in the first example embodiment is finished. The concrete processes are described in the following operation description.

### <Description of Operation>

Hereinafter, operation of the second example embodiment will be described with reference to the flowchart in FIG. 9. FIG. 9 is a diagram illustrating an overall flow of an operation example of the transmitter identifying apparatus 20 according to the second example embodiment. In FIG. 9, operations similar to those in FIG. 4 are denoted by the same step numbers.

First, in the environment where only a specific transmitter transmits a signal, the transmitter identifying apparatus 20 operates the receiving unit 11 to receive the signal transmitted by the transmitter. The feature extracting unit 12 extracts a radio wave feature from the received signal and applies the label representing the transmitter (first feature).

The learning unit 131 learns the radio wave feature to generate a discriminative model (classifier for discrimination) (step S11).

Next, in the environment where a large number of unspecific transmitters can transmit signals, the transmitter identifying apparatus 20 operates the receiving unit 11 to receive the signal transmitted by the transmitter.

The feature extracting unit 12 extracts a radio wave feature (second feature) from the received signal. The terminal that has transmitted the signal is unknown at this stage, and thus a label is not applied. The label estimating unit 21 performs the label estimation for the second feature by using the discriminative model (step S12). Details of an operation example in step S12 are similar to those in the first example embodiment, and therefore, descriptions thereof are omitted.

The label applying unit 134 applies the tentative label to the second feature that is judged to be applied with the label in step S122 (Yes in step S123, step S124). Otherwise, the tentative label is not applied to the second feature that is judged to not be applied with the label in step S122 (No in step S123).

The validation unit 211 validates the feature to which the tentative label is applied (step S21). The validation unit 211 performs k-fold cross validation only for the second features each applied with the tentative label, to test (validate) the second feature group. Specifically, the validation unit 211 extracts a second feature in which the maximum value of the output likelihood is a predetermined value or lower, and eliminates the extracted second feature from the feature group that are applied with the tentative labels.

### <Description of Advantageous Effects>

As described above, the transmitter identifying apparatus 20 includes the receiving unit 11, the feature extracting unit 12, and the label estimating unit 21. The label estimating unit 21 includes the learning unit 131, the likelihood calculating unit 132, the analyzing unit 133, the label applying unit 134, and the validation unit 211. With this configuration, it is possible to achieve an effect that, in the environment where a large amount of unspecific transmitters can transmit signals, the transmitter identifying apparatus 20 can apply an appropriate label to a feature that is extracted from the received data, as well as the effects in the first example embodiment. In other words, the second example embodiment improves the reliability of the feature that is applied with the tentative label.

### Third Example Embodiment

Next, a third example embodiment will be described in detail with reference to the drawings.

In the third example embodiment, another example alteration of the first example embodiment will be described. Providing a large amount of learning data in the vicinity of the discrimination border is important for enhancing the discrimination performance (classification performance) of the learning model. In other words, learning data that is separated from the discrimination border does not contribute to improvement in the discrimination performance, but only consumes computing cost of learning. In the third example embodiment, a step for reducing the computing amount is added to the processing in the analyzing unit 133.

### <Description of Configuration>

A transmitter identifying apparatus 30 according to the third example embodiment can have the same functional configuration as that in FIG. 2 described in the first example embodiment, and thus, descriptions thereof are omitted.

### <Description of Operation>

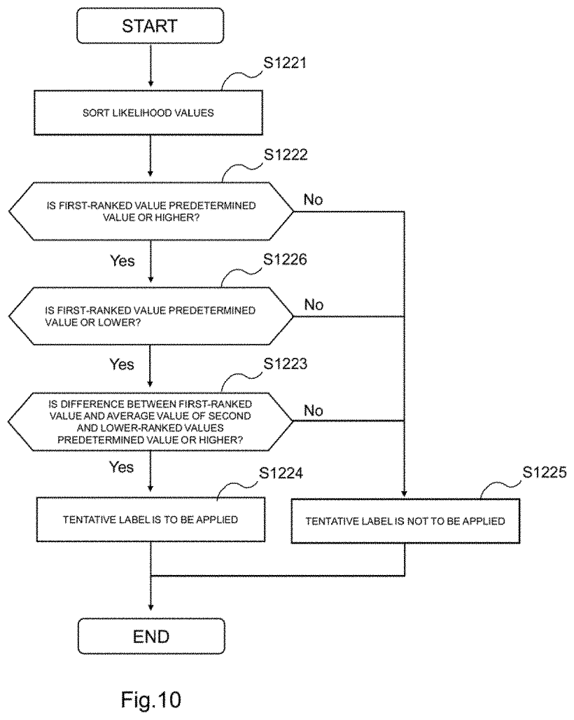

Hereinafter, operation of the third example embodiment will be described with reference to the flowcharts in FIGS. 4, 5, and 10. Note that FIG. 10 is a flowchart in which step S1226 is added to FIG. 6.

First, in the environment where only a specific transmitter transmits a signal, the transmitter identifying apparatus 30 operates the receiving unit 11 to receive the signal transmitted by the transmitter. The feature extracting unit 12 extracts a radio wave feature from the received signal, and applies the label representing the transmitter (first feature).

The learning unit 131 learns the radio wave feature to generate a discriminative model (classifier for discrimination) (step S11).

Next, in the environment where a large number of unspecific transmitters can transmit signals, the transmitter identifying apparatus 30 operates the receiving unit 11 to receive the signal transmitted by the transmitter.

The feature extracting unit 12 extracts a radio wave feature (second feature) from the received signal. The terminal that has transmitted the signal is unknown at this stage, and thus a label is not applied. The label estimating unit 13 performs the label estimation for the second feature by using the discriminative model (step S12).

The details of step S12 are described with reference to FIG. 5. FIG. 5 is a diagram illustrating a processing flow relating to labeling processing performed for the second feature. The likelihood calculating unit 132 inputs the second feature to the discriminative model generated in step S11, calculates likelihood for each label, and outputs a likelihood distribution (step S121).

The analyzing unit 133 analyzes the likelihood distribution generated in step S121, and determines whether to apply a tentative label (step S122).

An example of operation in step S122 is described in detail with reference to FIG. 10. FIG. 10 is a diagram illustrating a processing flow relating to step S122 (analysis of the likelihood distribution) illustrated in FIG. 5.

The analyzing unit 133 sorts the likelihood values of the likelihood distribution (step S1221).

The analyzing unit 133 determines whether the likelihood value ranked first as a result of sorting, is a predetermined value or higher (step S1222). In addition, the analyzing unit 133 determines whether the likelihood value ranked first, is a predetermined value (third predetermined value) or lower (step S1226). Furthermore, the analyzing unit 133 determines whether the difference between the first-ranked value and an average value of the second and lower-ranked values, is a predetermined value or higher (step S1223).

Note that the third predetermined value can be determined from the probability density distribution of likelihood values, as illustrated in FIG. 7. For example, the third predetermined value can be set to the mode of the peak (13a) of the likelihood values closer to 1. Selecting the third predetermined value in this manner enables eliminating data separated from the discrimination boundary, resulting in reduction in computing amount in learning processing.

In a case where the analyzing unit 133 determines as Yes in all steps S1222, S1223, and S1226, the analyzing unit 133 judges to apply the tentative label (step S1224). On the other hand, in a case where the analyzing unit 133 determines as No in at least one of the three steps, the analyzing unit 133 judges to not apply the tentative label (step S1225).

The description is returned to FIG. 5. The label applying unit 134 applies the tentative label to the second feature that is judged to be applied with the label in step S122 (Yes in step S123, step S124). Otherwise, the label applying unit 134 does not apply the tentative label to the second feature that is judged to not be applied with the label in step S122 (No in step S123).

The label estimating unit 13 continues the processing in step S12 until the processing from step S121 to step S124 is finished with respect to every second feature.

The description is returned to FIG. 4. Step S13 is not executed at the first loop. The learning unit 131 relearns the first feature that is extracted in step S11 and the second feature that is applied with the tentative label in step S12, to generate the discriminative model (classifier for discrimination) (step S14). Then, until increase of the number of second features that are applied with the tentative labels in the processing in step S12 becomes 0, the processing of step S12 and step S14 is repeated.

### <Description of Advantageous Effects>

As described above, the transmitter identifying apparatus 30 includes the receiving unit 11, the feature extracting unit 12, and the label estimating unit 13. The label estimating unit 13 includes the learning unit 131, the likelihood calculating unit 132, the analyzing unit 133, and the label applying unit 134. With this configuration, the transmitter identifying apparatus 30 provides the effects of the first example embodiment, with a smaller computing amount, due to the added determination process for determining whether the first-ranked value is the predetermined value or lower.

### Fourth Example Embodiment

Next, a fourth example embodiment will be described in detail with reference to the drawings.

### <Description of Configuration>

In the fourth example embodiment, a further specific example of the first example embodiment will be described.

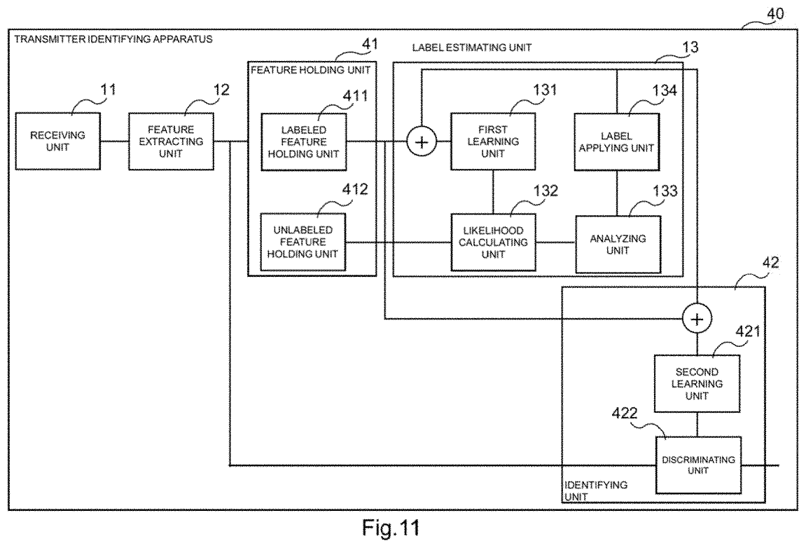

FIG. 11 is a block diagram illustrating an example of a functional configuration of a transmitter identifying apparatus 40 according to the fourth example embodiment. In the configuration illustrated in FIG. 11, the transmitter identifying apparatus 40 includes a receiving unit 11, a feature extracting unit 12, a feature holding unit 41, a label estimating unit 13, and an identifying unit 42. As to FIG. 11, the blocks denoted by the same reference signs as those in FIG. 2 can have the same functions as those described in the first example embodiment, and thus, descriptions thereof are omitted unless necessary. Note that the learning unit 131 included in the label estimating unit 13 is represented as a “first learning unit 131” in the fourth example embodiment, in order to distinguish the learning unit from a second learning unit, which is described later.

The transmitter identifying apparatus 40 identifies the transmitter, based on individual differences in radio wave transmitted from transmitters 900. In a learning phase, the transmitter identifying apparatus 40 learns a feature of a radio wave that is transmitted from a corresponding transmitter, with respect to each transmitter.

When receiving a radio wave, the transmitter identifying apparatus 40 extracts a feature from the received signal, and holds the feature. The transmitter identifying apparatus 40 learns the held feature to generate a discriminative model. In an inference phase, the transmitter identifying apparatus 40 inputs to the discriminative model the feature that is extracted from the received signal, and identifies the transmitter that is the transmission source of the received radio wave.

The feature holding unit 41 includes a labeled feature holding unit 411 and an unlabeled feature holding unit 412. Specifically, the labeled feature holding unit 411 holds a feature that is obtained in the environment where only a specific transmitter transmits a signal and that is applied with an appropriate label. The unlabeled feature holding unit 412 holds a feature that is obtained in the environment where a large number of unspecific transmitters transmit signals, and that is not applied with a label.

The identifying unit 42 includes a second learning unit 421 and a discriminating unit 422.

The second learning unit 421 learns the feature that is applied with the appropriate label and that is held by the labeled feature holding unit 411, and the feature that is applied with the tentative label by the label estimating unit 13, to generate a learning model (second classifier). Note that as described above, the feature that is applied with the tentative label by the label estimating unit 13, is held by the unlabeled feature holding unit 412.

The discriminating unit 422 uses, input data, the radio wave feature extracted by the feature extracting unit 12 from the radio wave received by the receiving unit 11, and uses the learning model (second classifier) generated in the second learning unit 421, whereby the discriminating unit 422 discriminates (identifies) the transmitter.

### <Description of Operation>

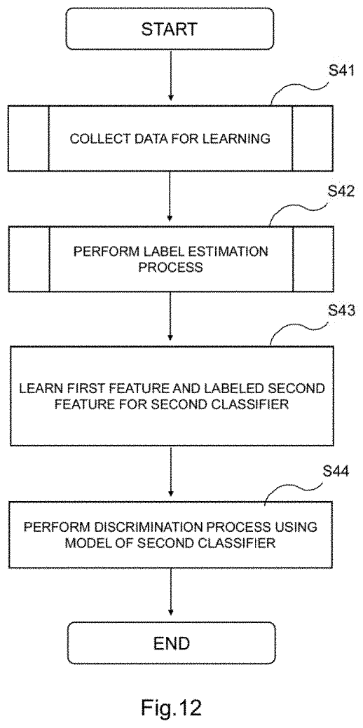

Hereinafter, operation of the fourth example embodiment will be described with reference to the flowcharts in FIGS. 12 to 14.

First, as illustrated in FIG. 12, the transmitter identifying apparatus 40 collects data for learning (step S41).

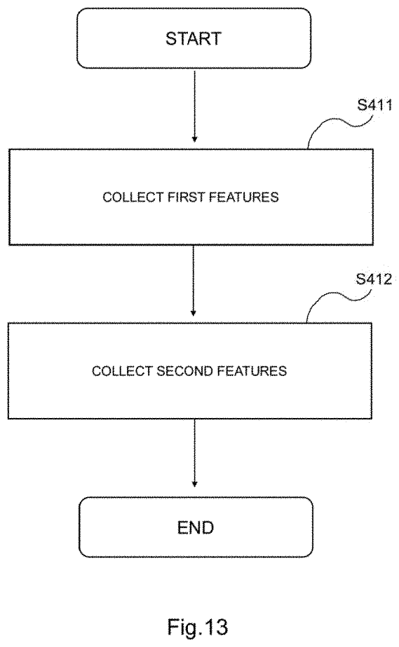

Step S41 is described with reference to FIG. 13. In the environment where only a specific transmitter transmits a signal, the transmitter identifying apparatus 40 operates the receiving unit 11 to receive the signal transmitted by the transmitter.

The feature extracting unit 12 extracts a radio wave feature from the received signal, and applies the label representing the transmitter (first feature). The feature holding unit 41 archives and stores the first feature in the labeled feature holding unit 411 (step S411).

Next, in the environment where a large number of unspecific transmitters can transmit signals, the transmitter identifying apparatus 40 operates the receiving unit 11 to receive the signal transmitted by the transmitter.

The feature extracting unit 12 extracts a radio wave feature (second feature) from the received signal. The feature holding unit 41 archives and stores the second feature in the unlabeled feature holding unit 412 (step S412). The terminal that has transmitted the signal is unknown at this stage, and thus a label is not applied.

Next, as illustrated in FIG. 12, the transmitter identifying apparatus 40 performs a label estimation process (step S42).

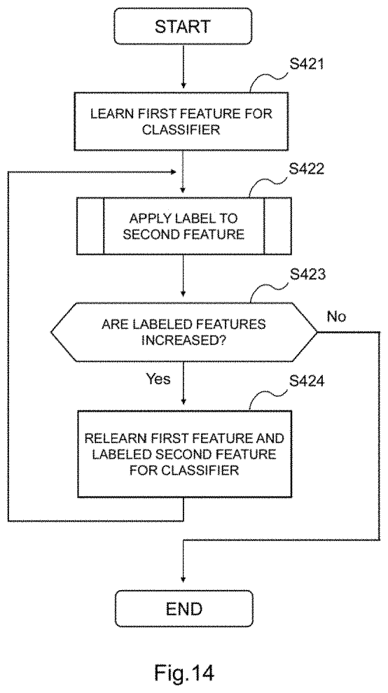

The details of step S42 are described with reference to FIG. 14. In the label estimating unit 13, the first learning unit 131 learns the first feature (labeled feature), which is archived in the feature holding unit 41, to generate a discriminative model (step S421).

The likelihood calculating unit 132 inputs the second feature (unlabeled feature), which is archived in the feature holding unit 41, to the discriminative model generated in step S421, calculates a likelihood for each label, and outputs a likelihood distribution.

The analyzing unit 133 analyzes the likelihood distribution generated in step S422, and determines whether to apply a tentative label.

The label applying unit 134 applies the tentative label to the second feature, which is judged by the analyzing unit 133 to be applied with the label. Otherwise, the tentative label is not applied to the second feature that is judged by the analyzing unit 133 to not be applied with the label (step S422).

Step S423 is not executed at the first loop (processing proceeds to the “Yes” side). The first learning unit 131 relearns both of the first feature that is extracted in step S421 and the second feature that is applied with the tentative label in step S422, to generate the discriminative model (step S424).

Until increase of the number of second features that are applied with the tentative labels in the processing in step S422 becomes 0, the processing in step S422 and step S424 is repeated.

The description is returned to FIG. 12. The second learning unit 421 learns the labeled feature (first feature), which is archived in the feature holding unit 41, and the feature (second feature), which is applied with the tentative label as a result of the label estimation by the label estimating unit 13, whereby the second learning unit 421 generates a second discriminative model (step S43).

Next, in another environment other than the environment where the first and second features are obtained (stored) in the feature holding unit 41, the transmitter identifying apparatus 40 operates the receiving unit 11 to receive a signal transmitted by a transmitter. The feature extracting unit 12 extracts a radio wave feature from the received signal. The discriminating unit 422 inputs the feature that is extracted in such another environment, to the second discriminative model generated in step S43, whereby the discriminating unit 422 identifies the transmitter.

### <Description of Advantageous Effects>

As described above, the transmitter identifying apparatus 40 includes the receiving unit 11, the feature extracting unit 12, the feature holding unit 41, the label estimating unit 13, and the identifying unit 42. The feature holding unit 41 includes the labeled feature holding unit 411 and the unlabeled feature holding unit 412. The label estimating unit 13 includes the first learning unit 131, the likelihood calculating unit 132, the analyzing unit 133, and the label applying unit 134. The identifying unit 42 includes the second learning unit 421 and the discriminating unit 422. This configuration is expected to improve the discrimination accuracy with respect to a signal that is received under a poor surrounding environment. Selection is repeated using the classifier model that is obtained by learning using a small number of labeled features. This enables applying the tentative labels to a large number of unlabeled features. Accordingly, the environmental resistance performance of discrimination accuracy is improved.

In the fourth example embodiment, the labels corresponding to the features used in learning of the first learning unit and of the second learning unit may be different from each other. For example, the label corresponding to the feature used in learning of the first learning unit may be a device type label, whereas the label corresponding to the feature used in learning of the second learning unit may be an individual label. In this case, the classification boundary of the learning model at the time of the label estimation is moderate more than in a case of using individual labels for both of the features. Thus, as compared with other cases, the discriminative model learned by the second learning unit has enhanced environmental variation resistance.

Next, the hardware configuration of the transmitter identifying apparatus described in the foregoing example embodiments will be described. Here, the hardware configuration of the transmitter identifying apparatus 10 according to the first example embodiment is representatively described.

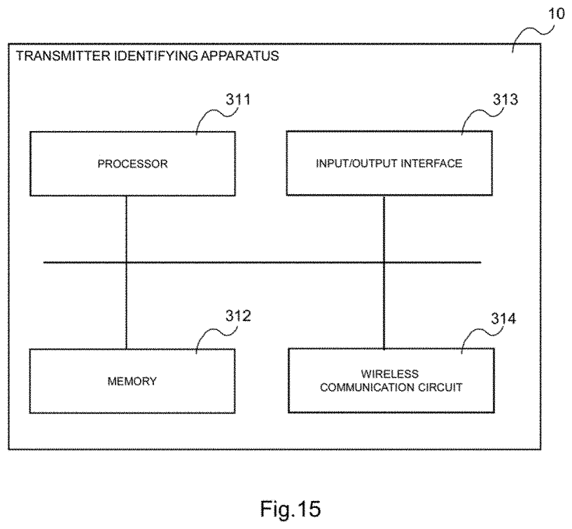

FIG. 15 is a diagram illustrating an example of a hardware configuration of the transmitter identifying apparatus according to the first example embodiment.

The transmitter identifying apparatus 10 can be constituted with an information processing apparatus (what is called a “computer”) and includes configuration illustrated as an example in FIG. 15. For example, the transmitter identifying apparatus 10 includes a processor 311, a memory 312, an input/output interface 313, a radio communication circuit 314, and so on. The constituent components such as the processor 311 are connected by an internal bus or the like, so as to be mutually communicable.

Note that the configuration illustrated in FIG. 15 are not intended to limit the hardware configuration of the transmitter identifying apparatus 10. The transmitter identifying apparatus 10 may include hardware that is not illustrated in the drawing and may not include the input/output interface 313, depending on necessity. The numbers of the processor 311 and so on included in the transmitter identifying apparatus 10 are not intended to limit to the example in FIG. 15. For example, a plurality of processors 311 may be included in the transmitter identifying apparatus 10.

The processor 311 is a programmable device, such as a Central Processing Unit (CPU), a Micro Processing Unit (MPU), or a Digital Signal Processor (DSP). Alternatively, the processor 311 may be a device such as a Field Programmable Gate Array (FPGA) or an Application Specific Integrated Circuit (ASIC). The processor 311 executes various programs including an operating system (OS).

The memory 312 is a Random Access Memory (RAM), a Read Only Memory (ROM), a Hard Disk Drive (HDD), a Solid State Drive (SSD), or the like. The memory 312 stores an OS program, an application program, and various kinds of data.

The input/output interface 313 is an interface of a display apparatus or an input apparatus, which are not illustrated in the drawing. The display apparatus is, for example, a liquid crystal display. The input apparatus is an apparatus for receiving user operation, such as a keyboard or a mouse.

The radio communication circuit 314 is a circuit, a module, or the like, which wirelessly communicates with other apparatuses. For example, the radio communication circuit 314 includes an RF (Radio Frequency) circuit.

The functions of the transmitter identifying apparatus 10 are implemented by various kinds of processing modules. The processing modules are implemented, for example, by executing programs stored in the memory 312 by the processor 311. The programs can be recorded in a computer-readable storage medium. The storage medium can be a non-transitory medium, such as a semiconductor memory, a hard disk, a magnetic recording medium, or an optical recording medium. In other words, the present invention can be embodied as a computer program product. The programs can be updated by downloading them via a network or by using a storage medium storing them. Furthermore, the processing modules may be implemented by semiconductor chips.

### Example Alterations

The configuration, operation, and so on of the transmitter identifying apparatus described in the first to the fourth example embodiments are merely examples, and these examples are not intended to limit the configuration and so on of the apparatus. For example, FIG. 2 illustrates, a case in which the feature extracting unit 12 and the label estimating unit 13 that are included in one apparatus, however, these functions may be included in separate apparatuses. In another example, a radio wave receiving apparatus including the receiving unit 11, and a transmitter discriminating apparatus including the feature extracting unit 12 and the label estimating unit 13, may be prepared. In other words, the transmitter identifying apparatus of the present disclosure may be constituted with one physical information processing apparatus or a plurality of physical information processing apparatuses. In the latter case, the plurality of the information processing apparatuses may be connected to one another via a network.

The transmitter identifying apparatus may be a virtual machine that emulates a plurality of computers in one computer. In other words, the transmitter identifying apparatus may be a calculating machine (physical machine), such as a server, or may be a virtual machine.

Alternatively, a lot of radio wave receiving apparatuses as described above may be disposed in a field, and the transmitter discriminating apparatus may be disposed as a server of a cloud system. Instead of this, the function of the feature extracting unit 12 may be implemented to a lot of radio wave receiving apparatuses disposed in a field, whereby load on a server of a cloud may be reduced.

A transmitter identifying program may be installed in a storage of a computer, to make the computer function as the transmitter identifying apparatus. The transmitter identifying program may be executed by a computer to make the computer execute the transmitter identifying method.

Although the plurality of the flowcharts used in the above descriptions illustrate a plurality of steps (processes) in a sequential manner, the execution order of the steps executed in each example embodiment is not limited to the illustration. In each example embodiment, the order of the steps illustrated in the drawing can be changed within a range of not hindering the processing, for example, such that processes are executed in parallel. In addition, the above-described example embodiments can be used in combination unless the processes do not conflict.

The whole or part of the example embodiments disclosed above can be described as in the following supplementary notes, but are not limited to the following.

### (Supplementary Note 1)

A transmitter identifying apparatus including:
a receiving unit (11, 101) configured to receive a signal from each of terminals;
a feature extracting unit (12, 102) configured to extract a feature from the signal received by the receiving unit (11, 101);
a first learning unit (103, 131) configured to learn a first feature of the signal that is known as a signal received from a terminal to be discriminated, and generate a first classifier for discriminating the terminal to be discriminated;
a likelihood calculation unit (104, 132) configured to input to the first classifier a second feature of the signal that is unknown whether the signal is received from the terminal to be discriminated, and calculate a likelihood distribution representing a likelihood for each terminal;
an analyzing unit (105, 133) configured to analyze the likelihood distribution, and determine whether to apply a tentative label to the second feature; and
a label applying unit (106, 134) configured to apply the tentative label to the second feature, based on a result of the analyzing unit.

### (Supplementary Note 2)

The transmitter identifying apparatus according to supplementary note 1, wherein
the analyzing unit (105, 133) is further configured to rearrange likelihood values in the likelihood distribution in descending order of a magnitude of the likelihood value, and apply the tentative label to the second feature when a highest likelihood value is equal to or higher than a first predetermined value and a difference value between the highest likelihood value and an average value of likelihood values other than the highest likelihood value is equal to or higher than a second predetermined value.

### (Supplementary Note 3)

The transmitter identifying apparatus according to supplementary note 2, wherein the analyzing unit (105, 133) is further configured to apply the tentative label to the second feature when the highest likelihood value is equal to or less than a third predetermined value.

### (Supplementary Note 4)

The transmitter identifying apparatus according to supplementary note 2 or 3, wherein
the receiving unit (11, 101) is configured to add noise to the received signal corresponding to the first feature while varying a magnitude thereof to generate a plurality of received signals having different levels of noise,
the feature extracting unit (12, 102) is configured to extract features for the plurality of received signals,
the first learning unit (103, 131) is configured to use a part of a plurality of the features to generate the first classifier, and input the feature which is not used for the generation of the first classifier to the first classifier to generate a probability density distribution,
the first predetermined value is a minimum value of a first peak in which the likelihood value expressed in the probability density distribution is closer to 1, and
the second predetermined value is a difference value between a mode value of a second peak in which the likelihood value is closer to 0 and the minimum value of the first peak.

### (Supplementary Note 5)

The transmitter identifying apparatus according to any one of supplementary notes 1 to 4, wherein the first learning unit (103, 131) is configured to regenerate, based on the first feature and the second feature to which the tentative label is applied, the first classifier for discriminating the terminal to be discriminated.

### (Supplementary Note 6)

The transmitter identifying apparatus according to any one of supplementary notes 1 to 5, further including a validation unit (211) configured to validate whether the temporary label applied to the second feature is appropriate.

### (Supplementary Note 7)

The transmitter identifying apparatus according to any one of supplementary notes 1 to 6, further including:
a first feature holding unit (411) configured to hold the first feature;
a second feature holding unit (412) configured to hold the second feature;
a second learning unit (421) configured to learn the feature held in each of the first and second feature holding units, and generate a second classifier for discriminating the terminal to be discriminated; and
a discriminating unit (422) configured to use the second classifier to discriminate the terminal.

### (Supplementary Note 8)

The transmitter identifying apparatus according to supplementary note 4, wherein the receiving unit (11, 101) is configured to add additive Gaussian noise to generate the plurality of received signals.

### (Supplementary Note 9)

The transmitter identifying apparatus according to supplementary note 5, wherein the first learning unit (103, 131) is configured to repeat the regeneration of the first classifier until the second feature to which the tentative label is applied is used up.

### (Supplementary Note 10)

The transmitter identifying apparatus according to any one of supplementary notes 1 to 9, wherein the first feature is a feature to which a label is applied, and which is extracted from
the signal received in an environment in which only the terminal to be discriminated exists, and the second feature is a feature to which the label is not applied, and which is extracted from the signal received in an environment in which a terminal other than the terminal to be discriminated also exists.

### (Supplementary Note 11)

A transmitter identifying method performed by a transmitter identifying apparatus including a receiving unit (11, 101) for receiving a signal from each of terminals, the transmitter identifying method including:
extracting a feature from the signal received by the receiving unit (11, 101);
learning a first feature of the signal that is known as a signal received from a terminal to be discriminated, and generating a first classifier for discriminating the terminal to be discriminated;
inputting to the first classifier a second feature of the signal that is unknown whether the signal is received from the terminal to be discriminated, and calculating a likelihood distribution representing a likelihood for each terminal;
analyzing the likelihood distribution, and determining whether to apply a tentative label to the second feature; and
applying the tentative label to the second feature, based on a result of the analysis.

### (Supplementary Note 12)

A program causing a computer mounted on a transmitter identifying apparatus including a receiving unit (11, 101) for receiving a signal from each of terminals to execute the processes of:
extracting a feature from the signal received by the receiving unit (11, 101);
learning a first feature of the signal that is known as a signal received from a terminal to be discriminated, and generating a first classifier for discriminating the terminal to be discriminated;
inputting to the first classifier a second feature of the signal that is unknown whether the signal is received from the terminal to be discriminated, and calculating a likelihood distribution representing a likelihood for each terminal;
analyzing the likelihood distribution, and determining whether to apply a tentative label to the second feature; and
applying the tentative label to the second feature, based on a result of the analysis.

The configuration of supplementary note 11 and the configuration of supplementary note 12 can be developed into any one of the configurations of supplementary notes 2 to 10 in the same way as in the case of supplementary note 1.

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

This application claims priority based on JP 2019-049814 filed on Mar. 18, 2019, the entire disclosure of which is incorporated herein.

### INDUSTRIAL APPLICABILITY

A discriminative model having robustness against environmental variation is generated, resulting in enhancing the discrimination accuracy in identifying a transmitter that is a radio wave transmission source.

### REFERENCE SIGNS LIST

10 to 40, 100 Transmitter Identifying Apparatus
11, 101 Receiving Unit
12, 102 Feature Extracting Unit
13, 21 Label Estimating Unit
41 Feature Holding Unit
42 Identifying Unit
103, 131 Learning Unit (First Learning Unit)
104, 132 Likelihood Calculating Unit
105, 133 Analyzing Unit
106, 134 Label Applying Unit
211 Validation Unit
311 Processor
312 Memory
313 Input/Output Interface
314 Radio Communication Circuit
411 Labeled Feature Holding Unit
412 Unlabeled Feature Holding Unit
421 Second Learning Unit
422 Discriminating Unit

What is claimed is:

1. A transmitter identifying apparatus comprising:
a memory storing instructions; and
receive a signal from each of terminals;
extract a feature from the received signal;
learn a first feature of the signal that is known as a signal received from a terminal to be discriminated;
generate a first classifier for discriminating the terminal to be discriminated;
input to the first classifier a second feature of the signal that is unknown whether the signal is received from the terminal to be discriminated;
calculate a likelihood distribution representing a likelihood for each terminal;
to analyze the likelihood distribution;
determine whether to apply a tentative label to the second feature; and
apply the tentative label to the second feature, based on a result of the analysis.

2. The transmitter identifying apparatus according to claim 1, wherein
the one or more processors are further configured to rearrange likelihood values in the likelihood distribution in descending order of a magnitude of the likelihood value, and apply the tentative label to the second feature when a highest likelihood value is equal to or higher than a first predetermined value and a difference value between the highest likelihood value and an average value of likelihood values other than the highest likelihood value is equal to or higher than a second predetermined value.

3. The transmitter identifying apparatus according to claim 2, wherein the one or more processors are further configured to apply the tentative label to the second feature when the highest likelihood value is equal to or less than a third predetermined value.

4. The transmitter identifying apparatus according to claim 2, wherein
the one or more processors are further configured to:
add noise to the received signal corresponding to the first feature while varying a magnitude thereof to generate a plurality of received signals having different levels of noise;
extract features for the plurality of received signals;
use a part of a plurality of the features to generate the first classifier; and
input the feature which is not used for the generation of the first classifier to the first classifier to generate a probability density distribution,
the first predetermined value is a minimum value of a first peak in which the likelihood value expressed in the probability density distribution is closer to 1, and
the second predetermined value is a difference value between a mode value of a second peak in which the likelihood value is closer to 0 and the minimum value of the first peak.

5. The transmitter identifying apparatus according to claim 1 wherein the one or more processors are further configured to regenerate, based on the first feature and the second feature to which the tentative label is applied, the first classifier for discriminating the terminal to be discriminated.

6. The transmitter identifying apparatus according to claim 1, wherein the one or more processors are further configured to validate whether the temporary label applied to the second feature is appropriate.

7. The transmitter identifying apparatus according to claim 1, wherein
the one or more processors are further configured to:
hold the first feature in the memory;
hold the second feature in the memory;
learn the first and second features held in the memory;
generate a second classifier for discriminating the terminal to be discriminated; and
use the second classifier to discriminate the terminal.

8. The transmitter identifying apparatus according to claim 4, wherein the one or more processors are further configured to add additive Gaussian noise to generate the plurality of received signals.

9. The transmitter identifying apparatus according to claim 5, wherein the one or more processors are further configured to repeat the regeneration of the first classifier until the second feature to which the tentative label is applied is used up.

10. The transmitter identifying apparatus according to claim 1, wherein the first feature is a feature to which a label is applied, and which is extracted from the signal received in an environment in which only the terminal to be discriminated exists, and
the second feature is a feature to which the label is not applied, and which is extracted from the signal received in an environment in which a terminal other than the terminal to be discriminated also exists.

11. A transmitter identifying method comprising:
receiving a signal from each of terminals;
extracting a feature from the received signal;
learning a first feature of the signal that is known as a signal received from a terminal to be discriminated;
generating a first classifier for discriminating the terminal to be discriminated;
inputting to the first classifier a second feature of the signal that is unknown whether the signal is received from the terminal to be discriminated;
calculating a likelihood distribution representing a likelihood for each terminal;
analyzing the likelihood distribution;
determining whether to apply a tentative label to the second feature; and
applying the tentative label to the second feature, based on a result of the analysis.

12. A non-transitory computer readable recording medium storing a program that causes one or more processors to execute the processes of:
receiving a signal from each of terminals;
extracting a feature from the received signal;
learning a first feature of the signal that is known as a signal received from a terminal to be discriminated;
generating a first classifier for discriminating the terminal to be discriminated;
inputting to the first classifier a second feature of the signal that is unknown whether the signal is received from the terminal to be discriminated;
calculating a likelihood distribution representing a likelihood for each terminal;
analyzing the likelihood distribution;
determining whether to apply a tentative label to the second feature; and
applying the tentative label to the second feature, based on a result of the analysis.
